(19) United States
(12) Patent Application Publication
(10) Pub. No.: US 2013/0295550 A1
(43) Pub. Date: Nov. 7, 2013

(54) REUSABLE GIFT BAG

(71) Applicant: LAKSHMI MULLAGURU, San Diego, CA (US)

(72) Inventor: LAKSHMI MULLAGURU, San Diego, CA (US)

(21) Appl. No.: 13/465,231

(22) Filed: May 7, 2012

(51) Int. Cl. B65D 33/00; B43L 1/10

(52) U.S. Cl. 434/417; 383/105

(57) ABSTRACT

A reusable gift bag of the present invention includes a portion of the bag that can receive a temporary marking. Reusable gift bags for holding a gift therein can be re-used after the gift has been removed. The message receiving panels are reactive to a disappearing ink solution and accordingly can be repeatedly written on allowing the ink fade away to become invisible. Alternatively, without using a specific ink-receiving panel, the entire portion of the gift bag handbags may be made from materials which are reactive to a disappearing markers.

### FIELD OF THE INVENTION

The present invention relates generally to gift bags having an ink-receiving panel portion of the bag that can receive temporary markings. The present invention is more particularly, though not exclusively, related to reusable gift bags for holding a gift therein and which can be used again after the gift has been removed. As a variation, without an ink-receiving panel, the entire gift bag can be used with temporary markings. As an alternative embodiment, handbags may have reusable message boards for women and girls to express their thoughts everyday as their personal message boards. The message boards can be written on, cleared, and written on again with a temporary marking. In addition, the entire handbags can be used with disappearing markings.

### BACKGROUND OF THE. INVENTION

Gift bags have become increasingly popular over the years with both youths and adults in many occasions. Although consumers can find almost any desirable message on gift bags, they are typically forced to purchase preprinted, mass produced gift bags that cannot be easily adapted to communicate the individual's own specific idea or message. The consumer is then limited to accepting the idea or message someone has already formed on the gift bags. If the consumer wishes to profess a unique or temporary thought or idea, the consumer must expend considerable time, effort and money to have a specific gift bag custom made, or customize the available generic bags.

Even if a gift bag can be custom made, if the message cannot be replaced with another, the gift bag cannot be repeatedly used. For example, if the custom made gift bag has a message saying that “Happy Birthday Billy,” and if it cannot be easily removed and written on again, it cannot be used for other occasions, such as for an anniversary, graduation . . . etc. If a custom made gift bag can be used only one time, this would result in wasted effort, money, and resources.

A reusable gift bag, such as that disclosed in U.S. Pat. No. 6,093,932 which issued in 2000, has been developed for the repeated use of a bag. In this prior art, a reusable tag was coupled to the gift bag. The reusable tag has an exterior surface which allows the wiping off of markings made with the writing instrument in order to clean the exterior surface of the reusable tag for the repeated use of the reusable tag.

Therefore, there is a need for a gift bag which can be easily personalized by the user to communicate a desired idea or message. Especially, there has been a growing need for a reusable product by providing a gift bag which can be written upon and which allows the customer to easily remove or change the message for repeated use.

Accordingly, it is an object of the present invention to provide a gift bag with a message panel upon which the gift giver inscribes a desired message and the receiver subsequently removes the message and inscribes another message for repeated use for the gift to the next person. In addition, even the entire gift bag, made from reactive materials to disappearing markings, can be used for the same purposes. As a variation, this invention also includes handbags with a message board upon which the user, particularly, women and girls, can inscribe a desired message and subsequently remove, alter or completely change the message being communicated, while carrying a bag for daily use.

### SUMMARY OF THE INVENTION

A reusable gift bag of the present invention includes a portion of the bag that can receive a temporary marking. Reusable gift bags for holding a gift therein can be re-used after the gift has been removed. Also as a variation, handbags can have reusable message panels intended for women and girls to express their thoughts everyday as their personal message boards. The message boards which are reactive to a disappearing ink can be repeatedly written on allowing the ink fade away to become invisible. Without using an ink-receiving panel, the entire portion of the gift bag or handbags may be made from materials which are reactive to disappearing markers.

### BRIEF DESCRIPTION OF THE DRAWING

The nature, objects, and advantages of the present invention will become more apparent to those skilled in the art after considering the following detailed description in connection with the accompanying drawings, in which like reference numerals designate like parts throughout, and wherein:

FIG. 1 depicts an exploded view of the reusable gift bag of the present invention, showing the writing implement attached to the bag and formed with an ink-receiving panel;

FIG. 2 depicts a perspective view of the present reusable gift bag showing the writing inscribed on the ink-receiving panel;

FIG. 3 depicts a side cross-sectional view of the present reusable gift bag showing the side view of the ink-receiving panel secured to the gift bag;

FIG. 4 depicts a perspective view of the present reusable gift bag showing a message written in a disappearing ink's fading away to become invisible;

FIG. 5 depicts a perspective view of the present reusable gift bag showing that a message written with a disappearing ink became completely invisible, ready for re-use;

FIG. 6 depicts a perspective view of the present reusable gift bag showing that a new message was written for the repeated use of the bag;

FIG. 7 depicts a perspective view of an alternative embodiment of a handbag variation of the reusable gift bag of the present invention having an ink-receiving panel, and showing its use for personal message board while carrying the bag;

FIG. 8 depicts a perspective view of a handbag with an ink-receiving panel, showing that messages can be written on, removed, and written on again using a disappearing ink; and

FIG. 9 is a flow chart having a series of method steps showing the marking of the reusable gift bag or handbag of the present invention, the removal of the marking, and the re-use of the Reusable Gift Bag or handbag.

### DETAILED DESCRIPTION OF A PREFERRED EMBODIMENT

### Gift Bag Embodiment

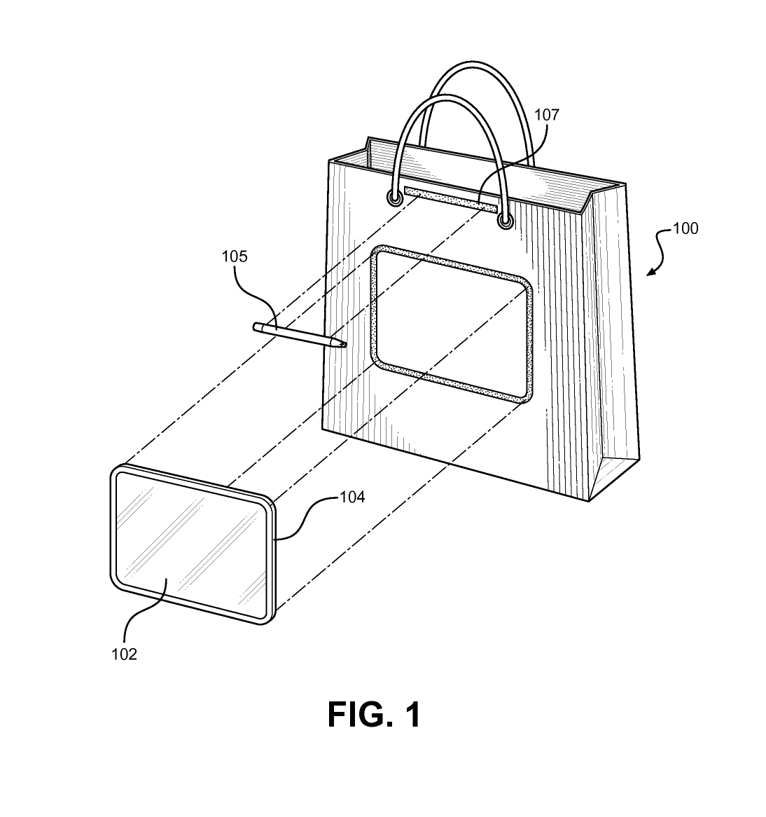

Referring initially to FIG. 1, an exploded view of the reusable gift bag of the present invention, generally designated 100, shows an exemplary writing implement attachable to the bag having an ink-receiving panel that can be used for a message board. Reusable gift bag 100 has an ink-receiving panel 102, attached to the surface of the bag, such as by using an adhesive 104. Alternatively, without departing from the scope of the present invention, ink-receiving panel 102 may be formed with the gift bag 100, or coated directly on the surface of the gift bag 100.

Writing implement 105 containing a disappearing ink which fades away over time to become invisible, is removably attached to one of the sides of the bag. A suitable attachment method includes, but is not limited to, incorporating a hook-and-loop fastening 107, such as Velcro™ attached to the bag 100 and writing implement 105.

In a preferred embodiment, the disappearing ink within writing implement 105 is a water-based acid-base indicator that changes from a colored to a colorless solution upon exposure to air. A suitable disappearing ink pen may be made of thymolphthalein or phenolphthalein, ethyl alcohol, sodium hydroxide, and water.

A disappearing ink pen can be removed by water, or more quickly with a cotton ball dampened with vinegar. A message written in a disappearing ink pen can also be removed by blowing on the spot because the carbon dioxide in your breath would fade the writing simply by lowering the pH level of the ink. Typically, messages written in a disappearing ink pen will seemingly vanish after 48 hours. Disappearing inks typically rely on the chemical reaction between thymolphthalein and a basic substance such as sodium hydroxide. Thymolphthalein, which is normally colorless, turns blue in solution with the base. As the base reacts with carbon dioxide, which is always present in the air, the pH drops below 10.5 and the color disappears.

The ink-receiving panel can be made of any suitable material that will erasably receive markings made by a nonpermanent, disappearing writing implement. For example, vinyl laminated panel can be used because it releases and accepts ink quickly.

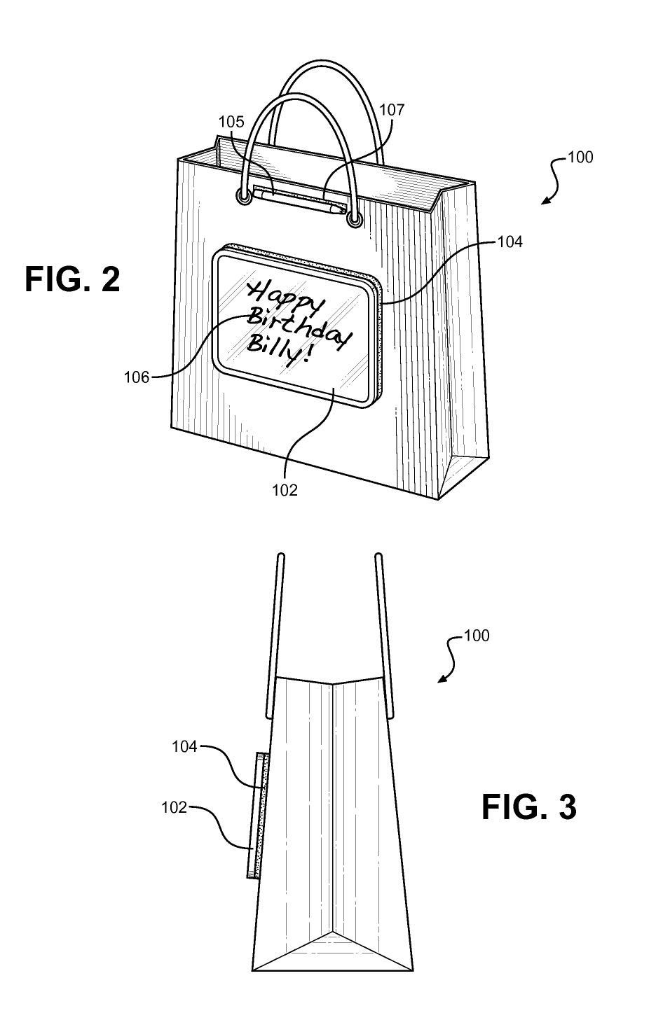

FIG. 2 is a perspective view of the present reusable gift bag 100 of the present invention showing message 106, “Happy Birthday Billy!” written on the ink-receiving panel using the writing implement 105 having disappearing ink.

FIG. 3 is a cross-sectional view of the present reusable gift bag. In a preferred embodiment, ink-receiving panel 102 is attached to the bag using adhesive 104. Alternatively, ink-receiving panel 102 may also be formed integrally to the bag 100, or coated thereon.

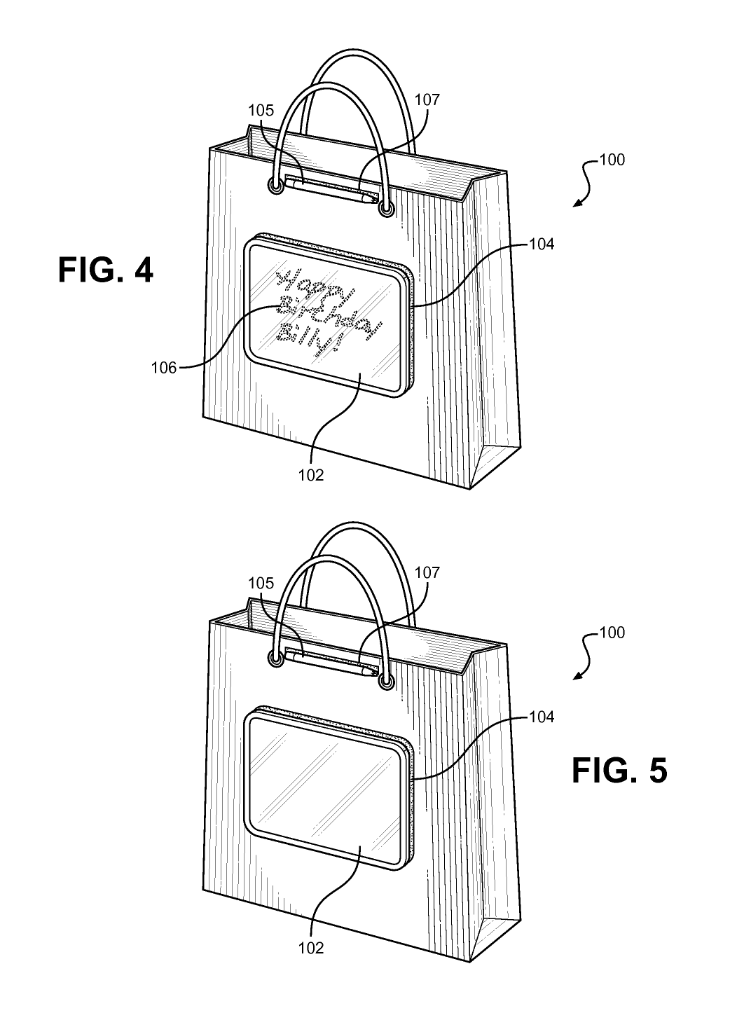

In FIG. 4, the message 106 written in a disappearing ink as shown in FIG. 2 is fading away to become invisible. Once it becomes completely invisible as shown in FIG. 5, it is ready for re-use, and the writing of another message. The user can then write another message for another gift.

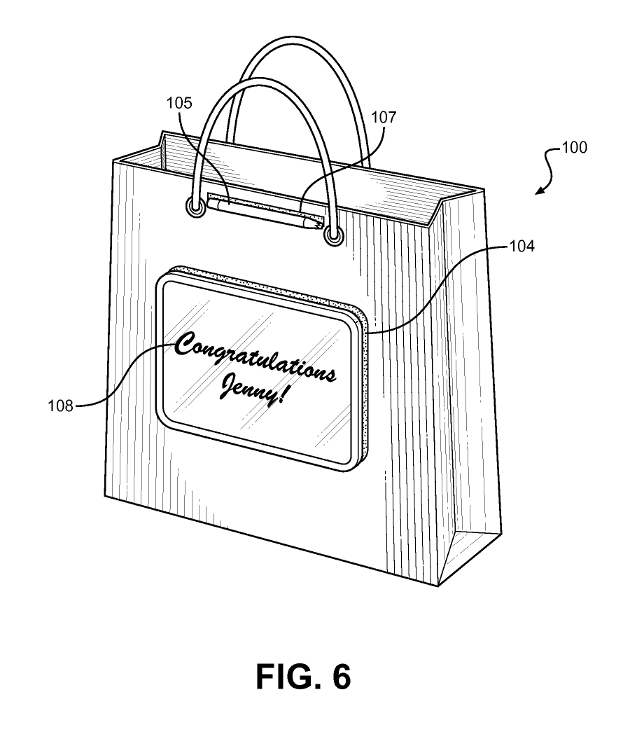

Referring now to FIG. 6, after the reusable gift bag 100 has been returned to its original state, it can be repeatedly used with another message. For instance, the gift bag was originally given to Billy for his birthday with a message 106 “Happy Birthday Billy” written in disappearing ink. Once the message 106 fades, Billy may then re-use the gift bag 100 for the gift to Jenny by writing the message 108 “Congratulations Jenny!”. Once Jenny receives this gift bag 100, and the message 108 fades, she can re-use it for the gift to another person, thus rendering this reusable gift bag an environmentally conscious product.

As an alternative embodiment of the present invention, the entire surface of gift bag 100 can be used for writing the personalized message using disappearing markings. In this case, the gift bag 100 is made of materials suitable for accepting and releasing ink, without the need of ink-receiving panel. In this case, the disappearing markings can be used on the entire gift bags for the repeated use.

### Handbag Embodiment

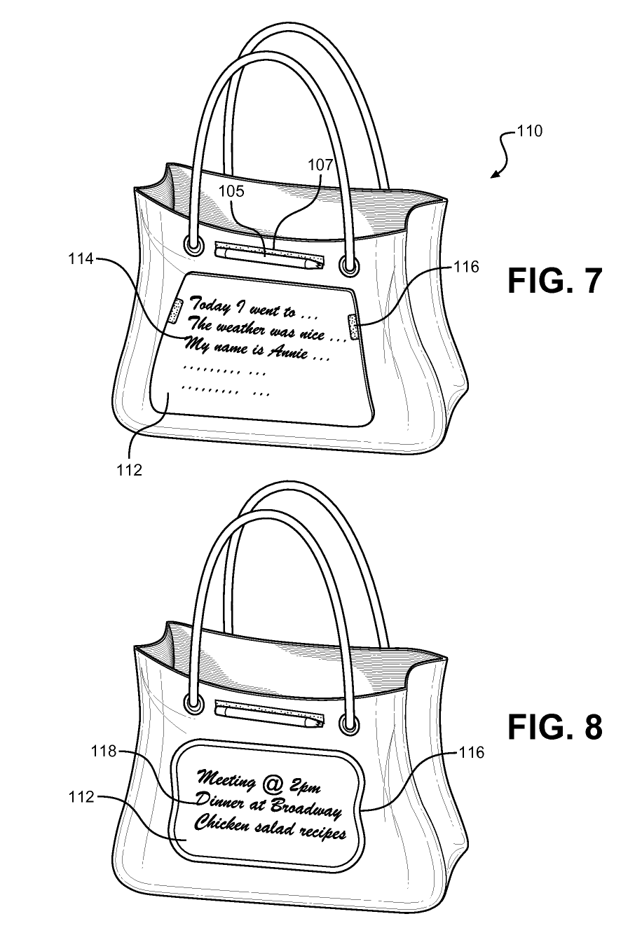

In an alternative embodiment of the reusable gift bag of the present invention, referring to FIG. 7, a perspective view of a handbag 110 having an ink-receiving panel 112 is shown. This embodiment allows a user to inscribe a desired message 114 on panel 112 and subsequently remove, alter or completely change the message 114 being communicated, while carrying a bag 110 for daily use. For esthetic purposes, the writing implement 105 (shown in dashed lines) with a disappearing ink may be attachable to the inside of the bag.

In this embodiment, the ink-receiving panel 112 may be removed for washing the bag 110, or for the occasion when the message board is not in use.

The ink-receiving panel 112 can be attached to the surface of the bag 110. For instance, panel 112 may be attached using glue, or may be sewn into the bag 110. As another alternative, the ink-receiving panel 112 can be attached to the bag 110 using hook and loop fasteners 116, such as Velcro™. The fasteners 116 on ink-receiving panel 112 and bag 110 will be permanently secured. In an alternative embodiment of the present invention, it is to be appreciated that ink-receiving panel 112 may be formed integrally to bag 110.

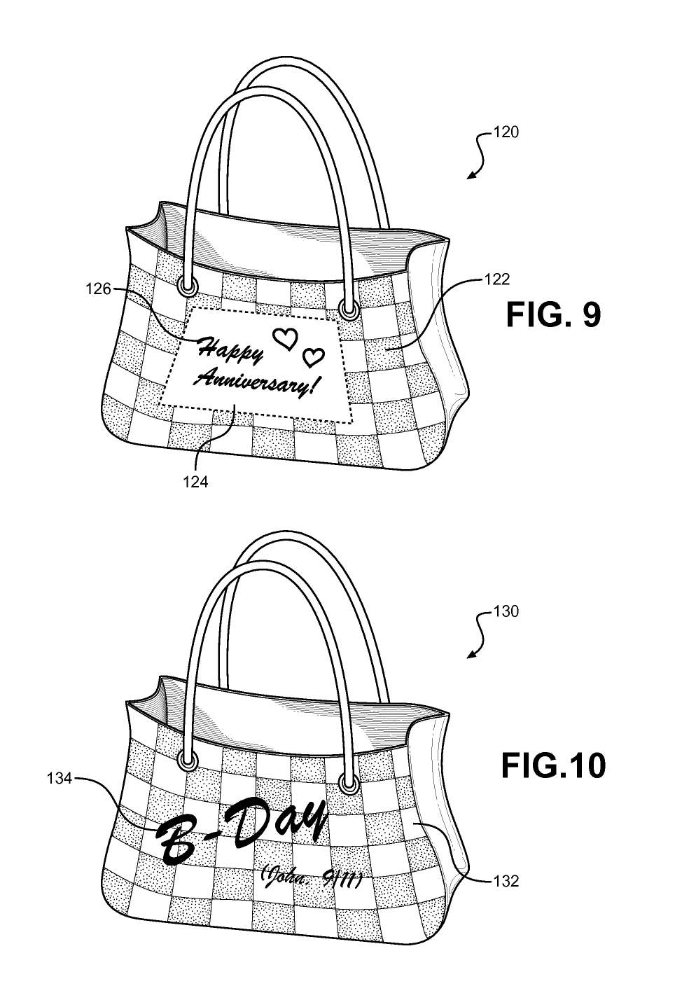

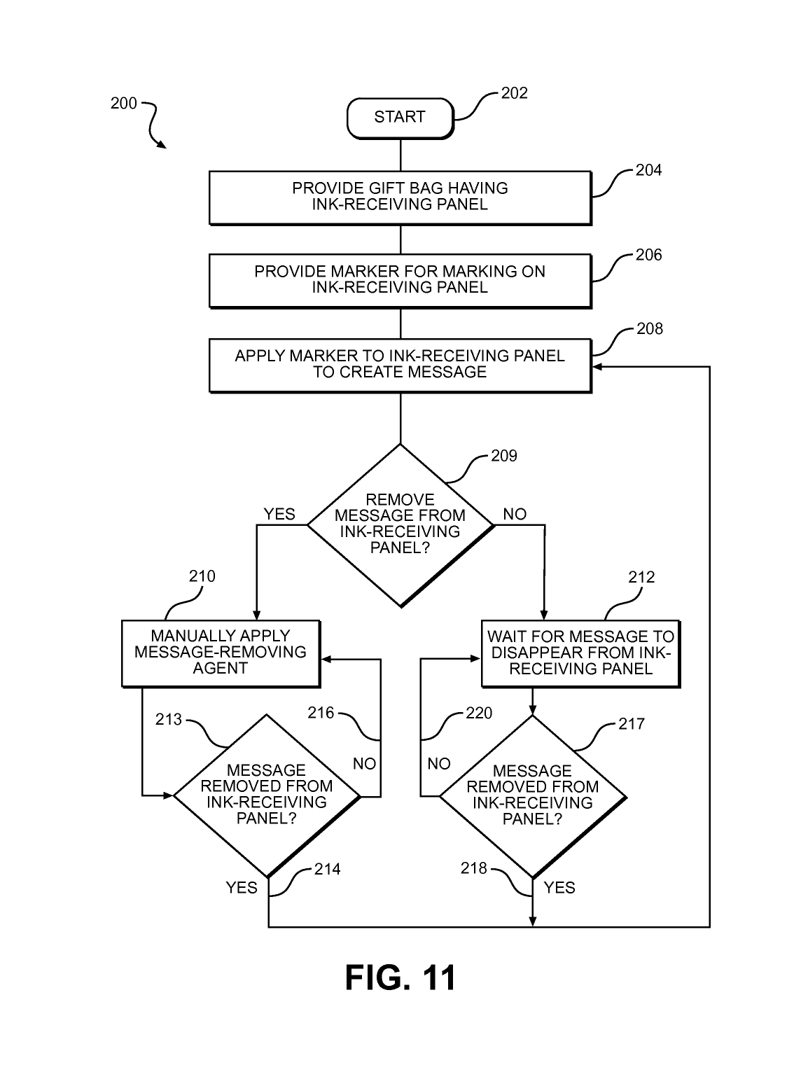

Referring now to FIG. 8, message 114 written on FIG. 7 in a disappearing ink can be replaced with other messages 118, once it vanishes. The messages can be anything including personal reminders, personal thoughts, assignments, menus, options . . . etc. The attached writing implement 105 and ink receiving panel 112 allows writing whenever or whatever the user wants to do so, while carrying a bag for daily use.

As a variation, the entire handbag can accommodate disappearing markings without any ink-receiving panel. In that case, the interaction between the specific ink and the bag's material should be taken into account. Some materials suitable for handbags may not be compatible with the use of ink on them.

Referring to FIG. 9, instead of using a separate ink-receiving panel attached to the bag, a space 124 (shown in dashed line) made from materials reactive to a disappearing ink can be designated to receive disappearing markers. Having prints 122 just like a regular bag, messages 126 can be written on the front space 124 of the bag 120. The absence of a ink-receiving panel can be advantageous for the aesthetic purposes of a handbag, and the user's more convenient way for carrying a handbag while the user still can write whenever or whatever he/she wants to do so.

As a variation to the bag 120, the entire bag 130 can be made from materials reactive to a disappearing ink. In this occasion, the bag 130 looks like just a regular handbag. Even though the bag 130 has prints 132, the user of the bag 130 can inscribe messages 134 over the prints 132, wherever on the bag 130, throughout the entire bag 130. In an alternative embodiment, due to the nature of the disappearing ink, without even a consideration of the materials which are reactive to a disappearing ink, messages written in a disappearing ink will disappear on its own anyway.

Referring now to FIG. 11, a series of method for steps both gift bag and handbag is shown as method 200. To the customers who want to use a reusable gift bag or a handbag to inscribe personal message as in method 200, a gift bag or handbag having an ink receiving panel and a marker for marking on ink-receiving panel would be provided in steps 204 and 206, respectively. Next, a user of the gift bag or handbag would apply the marker to an ink-receiving panel to create message in step 208.

When the user wants to remove the message from the ink-receiving panel, he or she can have two options in step 209. For instance, as a first option he can manually apply a message removing agent (such as water, cotton ball with vinegar, or blowing carbon dioxide . . . etc.) in step 210 to remove it immediately. Alternatively, he can simply wait for the message to disappear from the ink-receiving panel as in step 212.

If the user chooses to manually apply a message removing agent as in step 210 and the message is successfully removed as determined in step 213, method 200 return along path 214 to step 208 where the user can repeatedly apply a marker to an ink-receiving panel to create another message. If it is determined in step 213 that the message is indeed not been removed, method 200 returns along path 216 to step 210 where the user can manually re-apply the message removing agent to remove the message.

If the user chooses to wait for the message to disappear from an ink-receiving panel as in step 212 and once the message is removed as determined in step 217, method 200 returns along path 218 to step 208 where the user can write a new message on the ink-receiving panel. If the message does not disappear from an ink-panel as determined in step 217, method returns along path 220 to waiting step 212 for the message to disappear.

While there have been shown what are presently considered to be preferred embodiments of the present invention, it will be apparent to those skilled in the art that various changes and modifications can be made herein without departing from the scope and spirit of the invention.

I claim:

1. A reusable gift bag, comprising:
a bag having at least one sidewall;
said bag having an ink-receiving panel on said sidewall;
a marker reactive to said ink-receiving panel wherein when said marker is in contact with said ink-receiving panel, said marker leaves a mark; and
wherein said mark fades over time when exposed to a message removing agent.

2. The reusable gift bag of claim 1, wherein said bag is made from cloth.

3. The reusable gift bag of claim 1, wherein said bag is made from a natural product selected from the [cloth, paper, non-woven synthetic materials].

4. The reusable gift bag of claim 1, wherein said ink-receiving panel is formed integrally to said sidewall.

5. The reusable gift bag of claim 1, wherein said ink-receiving panel is coated onto a portion of at least one said sidewall.

6. The reusable gift bag of claim 1, wherein said marker further comprises a disappearing ink.

7. The reusable gift bag of claim 6, wherein said disappearing ink further comprises a water-based acid-base indicator.

8. The reusable gift bag of claim 6, wherein said disappearing ink further comprises thymolphthalein.

9. The reusable gift bag of claim 6, wherein said disappearing ink further comprises sodium hydroxide.

10. A method of using a reusable gift bag, comprising the steps of:
providing a gift bag having an ink-receiving panel;
providing a marker capable of marking on said ink-receiving panel;
said marker comprising a disappearing ink;
marking on said ink-receiving panel with said marker to create a message; and
removing said message

11. The method of claim 10, further comprising:
removing said message with water.

12. The method of claim 10, further comprising:
removing said message with vinegar.

13. The method of claim 10, further comprising:
removing said message carbon dioxide.

14. The method of claim 10, wherein said disappearing ink further comprises thymolphthalein and sodium hydroxide.
